(19) United States
(12) Patent Application Publication
(10) Pub. No.: US 2018/0185889 A1
(43) Pub. Date: Jul. 5, 2018

(54) FOREIGN SUBSTANCE REMOVAL METHOD AND FOREIGN SUBSTANCE REMOVAL DEVICE

(71) Applicant: MITSUBISHI CHEMICAL CORPORATION, Chiyoda-ku (JP)

(72) Inventors: Takeru ISHIMABUSHI, Chiyoda-ku (JP); Tooru KAJIWARA, Chiyoda-ku (JP)

(73) Assignee: MITSUBISHI CHEMICAL CORPORATION, Chiyoda-ku (JP)

(21) Appl. No.: 15/521,168

(22) PCT Filed: Oct. 22, 2015
(86) PCT No.: PCT/JP2015/079814

§ 371 Date: Apr. 21, 2017

(30) Foreign Application Priority Data
Oct. 24, 2014 (JP) 2014-217427

(51) Int. Cl. B08B 5/04

(52) U.S. Cl. CPC B08B 5/046

(57) ABSTRACT

Provided are a foreign substance removal method and foreign substance removal device that have excellent continuous operation stability for sheets and excellent foreign substance removal performance, during removal of foreign substance. Suction boxes (3a, 3b) are arranged at a position between two conveyance support bodies (1a, 1b) having an arrangement interval fulfilling prescribed conditions, said position having vertical symmetry relative to the sheet (2). Air is jetted towards the sheet (2) from air nozzles (4a, 4b) arranged inside the suction boxes (3a, 3b). Foreign substances are detached from upon the sheet (2) and the detached foreign substances are recovered using suction air having an average suction airspeed of 0.8-1.2 m/sec from openings (5a, 5b) in the suction boxes (3a, 3b).

### TECHNICAL FIELD

The present invention relates to a method of removing foreign substance attached to a sheet, and a device for removing foreign substance attached to a sheet.

### BACKGROUND ART

Conventionally, in manufacture of a sheet-like object, an object obtained by removing foreign substance such as dust attached to a surface of the sheet-like object has been shipped as a product.

As a method of removing foreign substance attached to a surface of the sheet-like object, for example, Patent Literature 1 proposes a belt-like cleaning device and a cleaning method. Patent Literature 1 proposes a method of removing foreign substance floating in a chamber by providing a nozzle in the chamber disposed to face at least one main surface of a traveling sheet-like object, blowing compressed air toward the sheet-like object from the nozzle to separate the foreign substance from the sheet-like object, and evacuating an inside of the chamber using air suction means.

The above-described foreign substance removal method is suitable when the sheet-like object has some rigidity.

### CITATION LIST

### Patent Literature

Patent Literature 1: JP 2004-195399 A

### SUMMARY OF THE INVENTION

### Problem to be Solved by the Invention

However, in the above-described foreign substance removal method, in the case of a sheet-like object such as a thin resin sheet which has low rigidity and easily warps, the sheet-like object moves up and down when the inside of the chamber is evacuated (sucked) using the air suction means. As a result, conveyance of the sheet-like object becomes unstable, and foreign substance of the sheet-like object may not be stably removed for a long time.

In addition, in the above-described method, when a conveying speed of the sheet-like object changes, an air flow of suction by the air suction means and an air flow of compressed air blown onto the sheet-like object mutually interfere. For this reason, a blowing pressure of compressed air on a surface of the sheet-like object decreases. As a result, the foreign substance may not be sufficiently peeled off from the sheet-like object, and performance of removing the foreign substance may deteriorate.

An object of the invention is to solve these problems. In more detail, an object of the invention is to provide a method of removing foreign substance attached to a sheet and a device for removing the foreign substance excellent in continuous operation stability and foreign substance removing performance.

### Means for Solving Problem

[1] A first outline of the invention is in a method of removing foreign substance attached to a sheet, the method sucking the foreign substance from a suction box B1 and a suction box B2 installed to face each other with the sheet interposed therebetween between a conveyance support A1 and a conveyance support A2 conveying the sheet, in which an average suction wind speed of suction wind from openings of the suction boxes B1 and B2 is in a range of 0.8 to 1.2 m/sec.

[2] The foreign substance removal method preferably includes a process of cutting the sheet before the foreign substance is sucked from the suction box B1 and the suction box B2.

[3] In the foreign substance removal method, the foreign substance may be separated from above the sheet by air blown from air nozzles inside the suction boxes B1 and B2.

[4] In the foreign substance removal method of [3], an installation interval R between the conveyance support A1 and the conveyance support A2 preferably satisfies the following Formula (1):

R≤320×(E×t²/d)^{0.25}−80 (1),
where R denotes the installation interval (mm) between the conveyance support A1 and the conveyance support A2, E denotes a Young's modulus (GPa) of the sheet, t denotes a thickness (mm) of the sheet, and d denotes density (g/cm³) of the sheet.

[5] In the foreign substance removal method, a pressure of air blown from the air nozzles may be set to a range of 2 to 60 kPa. The pressure of air blown from the air nozzles is preferably set to a range of 10 to 30 kPa.

[6] A difference Δv between average suction wind speeds of suction wind in the suction boxes B1 and B2 calculated from Formula (2) below is preferably 5.0 or less:

Δv=(|V1−V2|/Va)×100 (2)
where V1 denotes an average suction wind speed in the suction box B1,
V2 denotes an average suction wind speed in the suction box B2, and
Va denotes an average value of the average suction wind speeds in the suction boxes B1 and B2.

[7] An angle θ1 formed by a blowing direction of air blown from the air nozzles and a direction perpendicular to a sheet surface may be set to a range of 0 to 40°. The angle θ1 is preferably set to a range of 5 to 25°.

[8] An angle θ2 formed by a conveying direction of the sheet and a blowing direction obtained by projecting the blowing direction of air blown from the air nozzles onto the sheet surface may be set to a range of 0° to 5°.

[9] The foreign substance removal method may be used to remove foreign substance of a sheet having a Young's modulus in a range of 1.4 to 15.2 GPa and a thickness in a range of 0.5 to 15 mm.

[10] In the foreign substance removal method, the sheet preferably travels on the conveyance supports in an unrestrained state.

[11] A second outline of the invention is in foreign substance removal device attached to a sheet including a conveyance support A1 and a conveyance support A2 that convey the sheet, and a suction box B1 and a suction box B2 installed to face each other with the sheet interposed therebetween between the conveyance supports A1 and A2, in which an installation interval R between the conveyance support A1 and the conveyance support A2 satisfies the following Formula (1):

R≤320×(E×t²/d)^{0.25}−80 (1),
where R denotes the installation interval (mm) between the conveyance support A1 and the conveyance support A2, E denotes a Young's modulus (GPa) of the sheet, t denotes a thickness (mm) of the sheet, and d denotes density (g/cm³) of the sheet, and
air nozzles are included in the suction box B1 and the suction box B2.

[12] In the foreign substance removal device, an angle θ1 formed by a blowing direction of air blown from the air nozzles and a direction perpendicular to a sheet surface may be set to a range of 0 to 40°. The angle θ1 is preferably set to a range of 5 to 25°.

[13] An angle θ2 formed by a conveying direction of the sheet and a blowing direction obtained by projecting the blowing direction of air blown from the air nozzles onto the sheet surface may be set to a range of 0° to 5°.

### Effect of the Invention

Foreign substance removal method and foreign substance removal device of the invention are excellent in continuous operation stability and foreign substance removing performance when foreign substance attached to a surface of a sheet is removed. In particular, the method and the device are suitable to remove foreign substance attached to a surface of a sheet which has low rigidity and easily warps.

### BRIEF DESCRIPTION OF DRAWINGS

FIG. 1 is a side sectional view of foreign substance removal device when a roller is used as a conveyance support of the invention and a diagram for description of angles θ1 and θ2 of air;

FIG. 2 is a side sectional view of the foreign substance removal device when a belt conveyor is used as the conveyance support of the invention;

FIG. 3 is a schematic explanatory view illustrating an example of a sheet production line in the invention; and

FIG. 4 is a schematic side sectional view illustrating an example of a polymethyl methacrylate sheet continuous production line in the invention.

### MODE(S) FOR CARRYING OUT THE INVENTION

Hereinafter, a description will be given of foreign substance removal method and foreign substance removal device of the invention with reference to drawings.

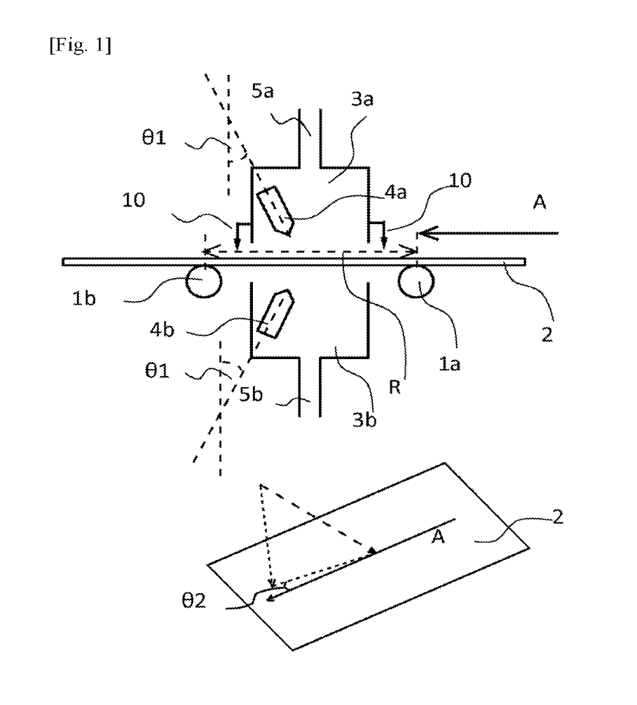

FIG. 1 illustrates an example of the foreign substance removal device of the invention in a sheet production line, and is a cross-sectional view of the removal device viewed from a side.

In FIGS. 1 to 4, a conveyance support A1 refers to a conveyance support 1a, and a conveyance support A2 refers to a conveyance support 1b. In addition, a suction box B1 refers to a suction box 3a, and a suction box B2 refers to a suction box 3b.

Foreign substance mentioned in the foreign substance removal method and the foreign substance removal device of the invention refers to foreign substance floating in the suction boxes 3a and 3b and/or foreign substance attached to a sheet.

(Conveyance Support)

The conveyance supports 1a and 1b are disposed at a predetermined interval in the sheet production line such that a sheet 2 travels substantially horizontally with respect to a ground in a direction of an arrow A.

A phrase “substantially horizontal with respect to the ground” means that surfaces of the conveyance supports 1a and 1b are shifted in a height direction by about 1 mm or less.

Even though FIG. 1 corresponds to an example of a case in which a roller is used as a conveyance support, either the roller or a belt conveyor may be used as the conveyance support.

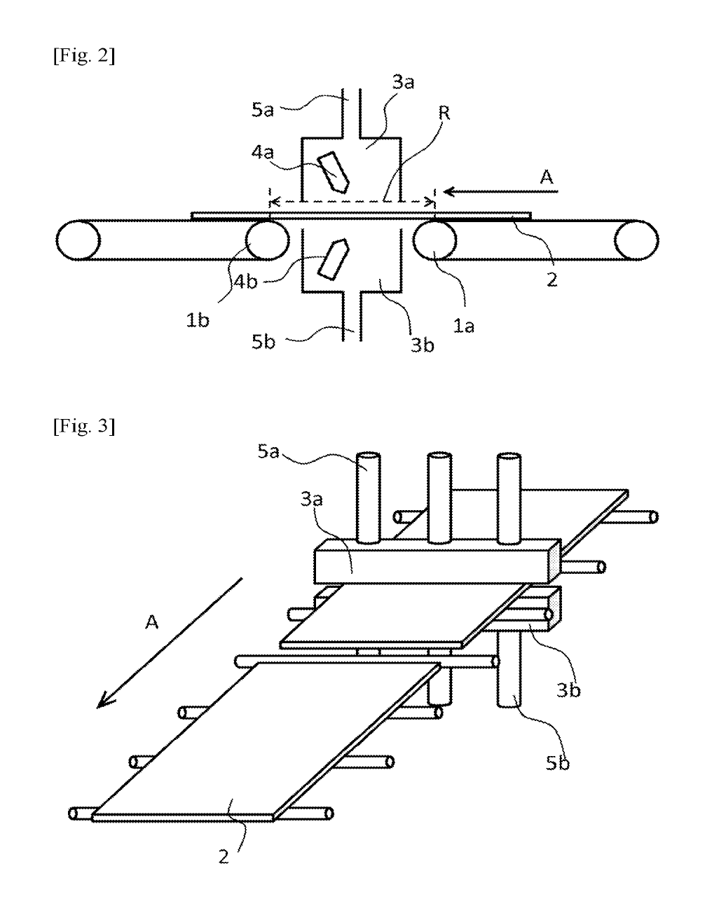

FIG. 2 is a cross-sectional view of the foreign substance removal device of the invention in the sheet production line viewed from a side when belt conveyors are used as the conveyance supports 1a and 1b. The belt conveyor is a conveying device having a belt attached to two or more rollers. A conveyed object is placed on the belt, and the belt is driven by rotation of the rollers to convey the conveyed object.

A specification of the conveyance support may include a plurality of rollers or a plurality of belt conveyors, or may include both a roller and a belt conveyor.

In the conveyance support, a known material may be used as a material of a portion in which the sheet corresponding to the conveyed object comes into contact with the conveyance support, and rubber or metal is generally used.

An installation interval R (mm) between the conveyance supports 1a and 1b refers to a distance from a point at which the sheet is separated from the support 1a to a point at which the sheet comes into contact with the support 1b. Installation is preferably performed to satisfy Formula (1) below when air is blown from an air nozzle as described below.

R≤320×(E×t²/d)^{0.25}−80 (1),

In Formula (1), E denotes a Young's modulus (GPa) of the sheet, t denotes a thickness (mm) of the sheet, and d denotes density (g/cm³) of the sheet.

A right side of Formula (1) is an index of difficulty in warping. As illustrated in FIG. 1, the installation interval R refers to a distance from the point at which the sheet is separated from the support 1a to the point at which the sheet comes into contact with the support 1b.

In the case of a rarely warping sheet (a sheet having a large Young's modulus or a thick sheet), the right side of Formula (1) is large, and thus a degree of freedom of the installation interval R is large.

On the other hand, in the case of an easily warping sheet (a sheet having a small Young's modulus or a thin sheet), the right side of Formula (1) is small, and thus it is particularly important to set a specific condition in which the installation interval R satisfies Formula (1) to stably perform a continuous operation while performing air blowing. When the installation interval R satisfies Formula (1), continuous operation stability may be compatible with foreign substance removing performance even in the case of the easily warping sheet.

(Sheet)

A state of the sheet 2 may correspond to a discontinuous sheet state in a conveying direction or a continuous state, and a plurality of sheets or one sheet may be present in a width direction. When a plurality of sheets 2 is arranged, a size of an interval therebetween is not limited.

The sheet 2 is not particularly limited, and examples thereof include a resin sheet such as an acrylic resin, a polycarbonate resin, and a polyethylene resin, and an inorganic sheet such as iron and glass. The invention is suitable when a sheet having a Young's modulus of 1.4 to 15.2 GPa or a sheet having a thickness of 0.5 to 15 mm is used.

The sheet 2 may be a single layer sheet or a multi-layer sheet. Further, the sheet 2 may not correspond to a single material. For example, the sheet 2 may correspond to a sheet having different laminated materials such as a laminate of glass/resin or metal/resin or a sheet made of different materials in the width direction.

Referring to a size of the sheet 2, a width of the sheet 2 is preferably smaller than a width of the conveyance supports 1a and 1b. A size of a longitudinal length of the sheet 2 is not particularly limited as long as the sheet 2 can be conveyed without any problem at the installation interval R between the conveyance supports 1a and 1b.

An embossed shape, a matted shape, and the like may be applied to a surface shape of the sheet 2 regardless of the presence/absence of a minute shape and the presence/absence of gloss on a surface.

FIG. 3 is a schematic perspective view of the sheet production line obliquely viewed from above. In FIG. 3, the sheet 2 is cut to obtain a required size and is in a discontinuous sheet shape in the conveying direction. Here, although not illustrated, the sheet may be cut along the conveying direction.

A sheet cutting process may be carried out in one stage or two stages depending on the required size.

When the cutting process is carried out in the two stages, for example, a continuous seamless sheet may be cut along the conveying direction in a first stage, and the sheet may be cut in a direction orthogonal to the conveying direction (the width direction of the sheet) while a cutting machine moves in synchronization with movement of the sheet in a second stage. FIG. 3 illustrates a state in which the suction boxes 3a and 3b described below are installed after the cutting process in the width direction of the sheet.

In the cutting process, cutting powder is generated due to cutting of the sheet and attached to the sheet as foreign substance. Thus, it is desirable to install the suction boxes described below immediately after cutting of the sheet in any one of the first stage of the cutting process and the second stage of the cutting process. In this case, at least one of a state, a width, and a length of the sheet changes in respective stages before the first stage of the cutting process, after the first stage of the cutting process, and after the second stage of the cutting process. However, the foreign substance removal method of the invention may be applied in any state.

A conveying speed of the sheet 2 is not particularly restricted. However, the conveying speed is preferably 30 m/min or less in terms of suppressing leakage of the foreign substance to the outside of the suction box. In addition, a lower limit of the conveying speed of the sheet 2 is preferably 0.5 m/min or more in terms of productivity.

(Foreign Substance)

Examples of the foreign substance attached to the sheet 2 in the invention include cutting powder at the time of cutting the sheet, dust in a manufacturing line atmosphere, textile waste, skin or hair of an operator, an insect, rust of manufacturing equipment, and a fallen painted piece.

(Suction Box)

In the invention, as illustrated in FIG. 1, the suction boxes 3a and 3b are installed to vertically face each other while interposing the sheet 2 between the conveyance support a1 and the conveyance support a2 that convey the sheet.

Suction ports 5a and 5b are connected to the suction boxes 3a and 3b.

The suction ports 5a and 5b are provided to form suction wind for sucking foreign substance floating in the suction boxes 3a and 3b and/or foreign substance attached to the sheet. For example, the suction ports 5a and 5b are connected to a dust collector through a duct.

It is preferably that foreign substance be rarely attached to a material of the suction boxes 3a and 3b, and the material of the suction boxes 3a and 3b have smooth surfaces and be rarely charged. Examples of the material of the suction boxes 3a and 3b include a stainless steel material and a resin material. Among these materials, the stainless steel material is preferable in terms of processability. When the resin material is used for the suction boxes 3a and 3b, antistatic treatment is preferably performed on a surface inside the suction boxes 3a and 3b.

One of more suction ports 5a and 5b may be included in the respective suction boxes. In addition, the same or different numbers of suction ports 5a and 5b may be provided, and the numbers may be arbitrarily set depending on purposes.

A structure of the suction boxes 3a and 3b is not particularly restricted when the structure has one open surface (surface facing the sheet 2), and an arbitrary shape may be set depending on purposes. From the viewpoint of improving foreign substance removing performance, a shape of a flow path cross section in the suction box preferably corresponds to a shape that can make the suction wind speed as uniform as possible. The structure of the suction boxes 3a and 3b is not particularly restricted. However, examples of the structure include a structure in which the flow path cross section corresponds to a circular shape or a polygon having four sides or more. In a case in which the flow path cross section corresponds to the polygon, an angular portion or a corner portion is preferably chamfered to prevent damage when the sheet 2 comes into contact with the suction box.

Widths of open surfaces of the suction boxes 3a and 3b in a direction perpendicular to the conveying direction of the sheet are not particularly restricted. However, the width is preferably larger than the width of the sheet 2 by about 100 mm in consideration of removability. Widths of the suction boxes 3a and 3b in the conveying direction of the sheet may be the same or different from each other. The width of the suction box 3b in the conveying direction of the sheet is not restricted since the suction box 3b is installed between the conveyance supports a1 and a2. However, the width of the suction box 3a in the conveying direction of the sheet is not restricted. A width of the open surface of the suction box 3a in the conveying direction of the sheet is preferably a width less than or equal to the installation interval R, and widths of open surfaces of the suction boxes 3a and 3b in the conveying direction of the sheet are more preferably substantially the same. It is more preferable that the open surfaces of the suction boxes 3a and 3b have the same shape and are disposed to vertically symmetrical.

When a dimension of the suction boxes 3a and 3b in the height direction is large, the suction wind speed on a suction box cross section is uniform. However, a weight and an installation space increase, and thus the dimension may be set to an arbitrary size depending on purposes.

As an arrangement in which the suction boxes 3a and 3b are vertically symmetrical, a vertical shift of installation positions of the suction boxes 3a and 3b is preferably 2 mm or less and more preferably 1 mm or less. When the shift of the installation positions of the suction boxes 3a and 3b is small, stability of a long-term operation tends to be excellent.

The vertical shift refers to an absolute value of a difference (|D1−D2|, unit: mm) between an interval (D1) between an opening of the suction box 3a and the sheet 2 and an interval (D2) between an opening of the suction box 3b and the sheet 2 when the open surfaces of the suction boxes 3a and 3b have same shape. In addition, the interval (D1, D2) refers to an average value of intervals measured at least at ten or more places at substantially equal intervals in whole circumferences of the openings of the suction boxes 3a and 3b.

The suction boxes 3a and 3b are preferably horizontally installed such that a difference between a maximum interval and a minimum interval of the opening of the suction box 3a and the sheet 2 and a difference between a maximum interval and a minimum interval of the opening of the suction box 3b and the sheet 2 are within 2 mm when the whole circumferences of the openings of the suction boxes 3a and 3b are viewed.

An interval between the suction boxes 3a and 3b and the sheet 2 may be set to 5 to 15 mm in consideration of vertical movement due to conveyance of the sheet 2. In addition, when the sheet 2 is in a sheet state, vertical movement due to conveyance easily increases, and thus the interval between the suction boxes 3a and 3b and the sheet 2 may be set 7 to 15 mm.

An aspect ratio of the openings of the suction boxes 3a and 3b may be arbitrarily set. When the aspect ratio of the opening portions is high, a plurality of suction ports 5a and 5b are provided side by side in a long side direction, so that the suction wind speed on the suction box cross section tends to be more uniform. For example, when the aspect ratio of the openings is 5 to 20 times, about three to ten suction ports 5a and 5b may be provided in the long side direction. Normally, the long side direction of the openings corresponds to the width direction of the sheet.

The suction ports 5a and 5b may be on surfaces directly facing the openings or surfaces adjacent thereto, and are preferably provided at places where the suction wind speed of suction wind in the suction boxes becomes more uniform.

In the invention, for example, a duct is connected to the suction ports 5a and 5b, and a dust collector for sucking the inside of the suction box is connected to a tip of the duct. It is preferable to provide a configuration capable of adjusting an output of the dust collector and providing a butterfly valve or an outside air suction port in the middle of the duct from the suction ports 5a and 5b to the dust collector so that the suction wind speed can be adjusted.

In the foreign substance removal method the invention, an average suction wind speed of suction wind at the opening of the suction box is 0.8 to 1.2 m/sec.

The average suction wind speed (unit: m/sec) refers to an average value of suction wind speeds of suction wind at the opening of the suction box, and is obtained by an equation below. A suction air flow rate refers to an air flow rate (unit: m³/sec) for sucking the inside of the suction box.

[Average suction wind speed (m/sec)]=[Suction air flow rate (m³/sec)]÷[Area of opening (m²)]

When the average suction wind speed is 0.8 m/sec or more, foreign substance detached from the sheet or foreign substance floating in the suction box is easily sucked, and foreign substance removing performance is improved. When the average suction wind speed is 1.2 m/sec or less, it is possible to prevent the sheet from moving up and down due to suction wind and coming into contact with the suction box, and thus continuous operation stability is improved. A lower limit of the average suction wind speed is more preferably 0.85 m/sec or more, and even more preferably 0.88 m/sec or more. An upper limit of the average suction wind speed is more preferably 1.15 m/sec or less, and even more preferably 1.12 m/sec or less.

In the invention, in the suction boxes installed above and below the sheet, a difference in average suction wind speed between upper and lower suction winds may be set to a range of −5.0 to 5.0(%) of the average suction wind speed. The difference in average suction wind speed is calculated from the following equation.

[Difference in average suction wind speed between upper and lower sides (m/sec)]=[(Average suction wind speed of upper suction box (m/sec))−(Average suction wind speed of lower suction box (m/sec))]/[(Average value of average suction wind speeds of upper and lower suction boxes (m/sec))]×100

In other words, a difference Δv between average suction wind speeds of suction wind in the suction boxes B1 and B2 calculated from Formula (2) below is preferably 5.0(%) or less.

Δv=(|V1−V2|/Va)×100 (2)
V1: Average suction wind speed (m/sec) in suction box B1
V2: Average suction wind speed (m/sec) in suction box B2
Va: Average value (m/sec) of average suction wind speeds in suction boxes B1 and B2

Vertical movement at the time of conveying the sheet may be suppressed by setting the difference Δv between the average suction wind speeds within a range of 5.0% or less. The difference Δv between the average suction wind speeds is more preferably 3.0% or less. In addition, the average suction wind speed in the suction box disposed below the sheet may be higher than the average suction wind speed in the suction box disposed above the sheet, and a difference between average suction wind speeds of upper and lower suction winds may be in a range of −5.0 to 3.0(%) of the average suction wind speed.

(Air Nozzle)

It is preferable to dispose the air nozzles 4a and 4b inside the suction boxes 3a and 3b to blow air onto the sheet surface. In particular, in the suction box disposed after cutting the sheet, there are a lot of foreign substance such as cutting powder having a large weight, and the foreign substance may not be sufficiently removed only by suction in the suction box.

An angle θ between the air nozzles 4a and 4b is defined as positive at a side at which the sheet enters the suction box (a right side of FIG. 1, referred to as a carrying-in side) on the assumption that a direction perpendicular to the sheet surface is 0°.

Foreign substance attached to an upper surface and a lower surface of the sheet 2 are separated by air blown from the air nozzles 4a and 4b, and the separated foreign substance are sucked and collected into the suction ports 5a and 5b in the suction boxes 3a and 3b.

Air nozzle shapes of the air nozzles 4a and 4b are not particularly limited, and may correspond to shapes that increase directivity of blown air and uniformity of a wind speed in the width direction of the sheet 2. In addition, a compact air nozzle is preferable.

Referring to arrangement of the air nozzles 4a and 4b, a plurality of air nozzles may be arranged side by side in the width direction of the sheet or one air nozzle may be arranged to cover a whole width of the sheet when air is uniformly blown to the whole sheet 2 in width direction.

Positions of the air nozzles 4a and 4b in the suction boxes are preferably set such that an air blowing portion is positioned at a location separated from wall surfaces of the suction boxes 3a and 3b of FIG. 1 on the carrying-in side of the sheet (the right side of FIG. 1) by 150 mm or more to a carrying-out side (a left side of FIG. 1) in terms of removability of foreign substance.

The air nozzles 4a and 4b are preferably designed to be able to supply air while controlling an air pressure using a pressure reducing valve or a pressure gauge.

A pressure of air blown from the air nozzles may be set to 2 kPa or more and 60 kPa or less.

When the air pressure is 2 kPa or more, foreign substance is easily separated from the sheet surface, and foreign substance removing performance tends to be improved. In addition, when the air pressure is 60 kPa or less, leaking of foreign substance to the outside of the suction box is suppressed, and foreign substance removing performance tends to be improved. A lower limit of the pressure of blown air is more preferably 3 kPa or more, and even more preferably 10 kPa or more. An upper limit of the pressure of blown air is more preferably 30 kPa or less, and even more preferably 20 kPa or less.

Here, the pressure of air blown from the air nozzles refers to a pressure calculated by converting a pressure measured by the pressure reducing valve having the pressure gauge connected to a portion within 20 cm from the air nozzles in an air line connected to the air nozzles using the following Equation 1.

$$[ Equation 1 ]$$

$$( \begin{matrix}Pressure of air \\ blown from air \\ nozzle\end{matrix} ) = ( \begin{matrix}Pressure measured by \\ pressure reducing \\ valve having pressure \\ gauge connected to \\ air line\end{matrix} ) \times ( \frac{\begin{matrix}Cross \text{-} sectional \\ area of air line\end{matrix}}{\begin{matrix}Cross \text{-} sectional \\ area of outlet \\ of air nozzle\end{matrix}} )$$

An angle (01 of FIG. 1) formed by a blowing direction of air blown from the air nozzles 4a and 4b and the direction perpendicular to the sheet surface may be set to 0 to 40°. When the angle of air is 0° or more, foreign substance is easily separated from the sheet, and foreign substance removing performance tends to be improved. When the angle θ1 of air is 40° or less, leakage of foreign substance to the outside of the suction box is suppressed, and foreign substance removing performance tends to be improved. A lower limit of the angle θ1 of air is more preferably 5° or more. An upper limit of the angle of air is more preferably 25° or less.

An angle (02 of FIG. 1) formed by the conveying direction of the sheet and a blowing direction obtained by projecting the blowing direction of air blown from the air nozzles onto the sheet surface may be set to a range of 0° to 5°. This angle indicates inclination of the air blowing direction in the width direction of the sheet and may be inclined to the left or the right in the width direction. Within this range, a traveling state of the sheet can be stably maintained, and foreign substance removing performance tends to be improved.

In the invention, the sheet 2 may be allowed to travel on the conveyance supports 1a and 1b by being put in an unrestrained state. Here, the unrestrained state refers to a state in which the sheet traveling on the conveyance support is in contact with the conveyance support only on one surface of one side of the sheet.

A method below may be given as a specific method of putting the sheet in the unrestrained state.

In more detail, conventionally, in the production line of the sheet-like object, a traveling sheet may be interposed between substantially columnar nip rollers disposed to face the conveyance support, or a traveling sheet may be interposed between a pair of substantially columnar nip rollers disposed to face each other in order to prevent the sheet from being unstable.

However, when the nip rollers are disposed as described above, there is a concern that foreign substance attached to the sheet may stick to surfaces of the nip rollers or the conveyance support to scratch the surface of the traveling sheet.

In the foreign substance removal method of the invention, the sheet may be stably conveyed without the surface of the traveling sheet being scratched even when the sheet is in the unrestrained state by setting the installation interval R of the conveyance support and the average suction wind speed of the suction box to the above-described condition.

An interval from a distal end portion of the air nozzles 4a and 4b to the sheet 2 may be set to 5 to 15 mm in consideration of vertical movement due to conveyance of the sheet 2. In addition, when the sheet 2 is in the sheet state, vertical movement due to conveyance easily increases, and thus the interval from the distal end portion of the air nozzles 4a and 4b to the sheet 2 may be set to 7 to 15 mm. The interval from the distal end portion of the air nozzles 4a and 4b to the sheet 2 is preferably narrow in terms of suppressing consumption of air blown from the air nozzles.

In the invention, the distal end portion of the air nozzle may protrude outside the suction box depending on purposes.

### EXAMPLES

Hereinafter, the invention will be described using Examples.

<Method of Evaluating Continuous Operation Stability>

An automatic stop system was installed. In this system, a contact detection sensor is included at a lower end of a suction box installed on an upper surface of a sheet, and suction of the suction box is automatically suspended when the sheet touches the contact detection sensor. Specifically, as illustrated in FIG. 1, a contact detection sensor 10 was installed at each of an upstream edge and a downstream edge of a lower end of the suction box 3a. The contact detection sensor 10 includes a urethane rotating body at a distal end of a rod-like portion, and an interval between a sheet surface and the rotating body was set to 2.0 mm. When the sheet touches the rotating body, the contact detection sensor outputs a signal, and suction in the suction box is suspended.

An operation of removing foreign substance was carried out for a certain period of time under a predetermined condition, and continuous operation stability was evaluated according to the following criteria depending on whether the automatic stop system was operated.
◯: After starting the operation, the automatic stop system did not operate for 1 hour or more, and continuous operation stability was excellent.
x: After the starting operation, the automatic stop system operated within 1 hour, and continuous operation stability was poor.
xx: The automatic stop system operated immediately after the operation starts, and continuous operation stability was significantly poor.

<Method of Evaluating Foreign Substance Removing Performance>

Adhesion states of foreign substance on an upper surface of the sheet before entering the suction box and after exiting the suction box were photographed using a video camera, the numbers of foreign substance attached to the sheet before entering the suction box and after exiting the suction box were counted, foreign substance removal rate on the upper surface side of the sheet was calculated, and foreign substance removing performance was evaluated according to the following criteria.
⊙: Foreign substance removal rate is 99% or more
◯: Foreign substance removal rate is 95% or more and less than 99%
Δ: Foreign substance removal rate is 90% or more and less than 95%
x: Foreign substance removal rate is less than 90%

<Method of Measuring Young's Modulus>

Measured in accordance with JIS K7161

<Method of Measuring Density>

Measured in accordance with JIS K7112

<Method of Measuring Average Suction Wind Speed>

An average suction wind speed refers to an average value of suction wind speeds of suction wind at an opening of the suction box, and was obtained by the following equation.

(Average suction wind speed)=(Suction air flow rate)÷(Area of opening)

The above-mentioned suction air flow rate refers to an air flow rate of suction wind for sucking the inside of the suction box, and was measured in accordance with JIS A1431-1994 using the following method.

An anemometer (product name: Crimomaster model 65, manufactured by CANOMAX Co., Ltd.) was inserted from a wind speed measuring port (short pipe having a piping diameter of about 15 A) provided in the duct at a linear portion of approximately 0.5 m upstream of the duct connected to the suction box, and a wind speed value was measured 20 times. Referring to the wind speed value, instantaneous values of wind speeds were read every 30 seconds for 600 seconds for each time, and an average value for 20 times was set to a wind speed value at each position. An average value of these 20 wind speed values was set to the average suction wind speed.

<Method of Measuring Difference Between Upper and Lower Average Suction Wind Speeds>

A value calculated by an equation below was set to a difference (%) between upper and lower average suction wind speeds.

(Difference between upper and lower average suction wind speeds)={(Average suction wind speed of upper suction box)−(Average suction wind speed of lower suction box)}/{(Average value of average suction wind speeds of upper and lower suction boxes)}×100

### Example 1

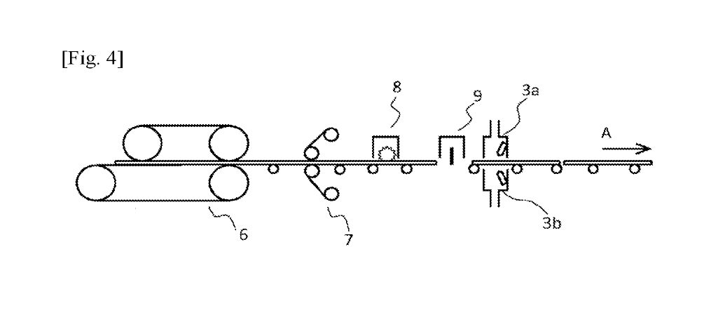

In a polymethyl methacrylate sheet continuous production line illustrated in FIG. 4, a surface protective film 7 (made of polyethylene, thickness 90 μm) was attached in line by a masking adhesive device to both upper and lower surfaces of a 5 mm thick and 350 mm wide polymethyl methacrylate sheet discharged onto a roller 6 from the sheet shaping device at a conveying speed of 1 m/min. Subsequently, a center was cut by a circular saw cutting machine 8 along a flow direction of the sheet to obtain two sheets having a width of 173 mm. Subsequently, the sheet was cut in the width direction by a circular saw cutting machine 9 in a direction perpendicular to the flowing direction of the sheet to obtain a sheet having a sheet length of 1,500 mm.

A pair of stainless box-shaped suction boxes 3a and 3b having a width of 380 mm×a length of 180 mm×a height of 250 mm (a plate thickness of 2 mm) was installed vertically symmetrically between a roller immediately after the circular saw cutting machine 9 and a roller subsequent thereto (a roller interval 560 mm) such that an opening surface of the suction box was parallel to the sheet and an interval from the sheet was 10 mm.

One circular suction port having a caliber of 100 mm is provided on a surface facing the opening inside the suction box, and is connected to the dust collector with a ϕ100 mm aluminum duct. In addition, three air nozzles (121 mm wide, trade name: TAIFUJet, made by IKEUCHI & Co., Ltd) are installed without any gap in the width direction at a position of 150 mm from an entrance of the sheet and a height at which an interval from a distal end portion of the air nozzle to the sheet is 10 mm inside the suction box. In addition, a center of a nozzle in the middle matches a center of the suction box in the width direction.

In addition, as illustrated in FIG. 1, the contact detection sensor 10 for evaluating continuous operation stability was installed at a position of 100 mm from both ends of the upstream edge and the downstream edge of the lower end of the suction box 3a.

Continuous production of polymethyl methacrylate sheets was carried out by setting a pressure and an angle of air blown from the air nozzle to 25 kPa and 10° and setting the average suction wind speed of suction wind inside the suction box to 0.9 m/sec. Evaluation results are shown in Table 1.

### Examples 2 to 12

Continuous production of polymethyl methacrylate sheets was carried out in the same manner as in Example 1 except that conditions described in Table 1 were changed. Evaluation results are shown in Table 1.

### Example 13

Continuous production of polymethyl methacrylate sheets was carried out in the same manner as in Example 1 except that a nip roller was installed at a position 1 m away from an end portion of the suction box at a downstream side in the conveying direction of the sheet. Evaluation results are shown in Table 1. Even though continuous operation stability and foreign substance removing performance were excellent, as foreign substance removal after cutting the sheet, foreign substance (debris due to circular saw cutting) attached to the sheet stuck to a surface of the nip roller, and a phenomenon of intermittent scratches on the surface of the sheet was observed.

### Example 14

Continuous production of polymethyl methacrylate sheets was carried out in the same manner as in Example 1 except that the conveying speed of the sheet was changed to 1 m/min. Evaluation results are shown in Table 1. Even when the conveying speed of the sheet was changed, continuous operation stability and foreign substance removing performance were excellent.

### Example 15

Continuous production of polymethyl methacrylate sheets was carried out in the same manner as in Example 1 except that the angle of air was changed to 45°. Evaluation results are shown in Table 1. Continuous operation stability was excellent due to the increased air angle when compared to Example 1. However, with regard to foreign substance removing performance, foreign substance removal rate was in a range of 90% or more and less than 95%.

### Reference Example 1

Continuous production of polymethyl methacrylate sheets was carried out similarly Example 1 except that air was not blown from the air nozzle toward the sheet. Evaluation results are shown in Table 1. Even though continuous operation stability was excellent, foreign substance removal performance after cutting the sheet was low since air was not blown from the air nozzle toward the sheet. A case of removing foreign substance other than after cutting the sheet was at a level having no practical problem.

### Comparative Example 1

Continuous production of polymethyl methacrylate sheets was carried out in the same manner as in Example 1 except that the average suction wind speed was set to 1.3 m/sec. Evaluation results are shown in Table 1. Since the average suction wind speed exceeded 1.2 m/sec, the sheet came into contact with the suction box and could not continuously operate.

### Comparative Example 2

Continuous production of polymethyl methacrylate sheets was carried out in the same manner as in Example 1 except that the average suction wind speed was set to 0.6 m/sec. Evaluation results are shown in Table 1. Since the average suction wind speed was too low, and foreign substance removing performance was low even when air was blown from the air nozzle toward the sheet.

TABLE 1

Condition for Sheet

| | | | Young's | |
|---|---|---|---|---|
| | Thickness t | Density d | modulus E | |
| | mm | g/cm³ | Gpa | Material |
| Example 1 | 5 | 1.19 | 3.14 | PMMA |
| Example 2 | 5 | 1.19 | 3.14 | PMMA |
| Example 3 | 5 | 1.19 | 3.14 | PMMA |
| Example 4 | 5 | 1.19 | 3.14 | PMMA |
| Example 5 | 5 | 1.19 | 3.14 | PMMA |
| Example 6 | 5 | 1.19 | 3.14 | PMMA |
| Example 7 | 5 | 1.19 | 3.14 | PMMA |
| Example 8 | 1.5 | 1.19 | 3.14 | PMMA |
| Example 9 | 1 | 7.8 | 200 | Iron |
| Example 10 | 5 | 1.19 | 3.14 | PMMA |
| Example 11 | 3 | 1.19 | 3.14 | PMMA |
| Example 12 | 5 | 1.23 | 2.45 | PC |
| Example 13 | 5 | 1.19 | 3.14 | PMMA |
| Example 14 | 5 | 1.19 | 3.14 | PMMA |
| Example 15 | 5 | 1.19 | 3.14 | PMMA |
| Reference | 5 | 1.19 | 3.14 | PMMA |
| Example 1 | | | | |
| Comparative | 5 | 1.19 | 3.14 | PMMA |
| Example 1 | | | | |
| Comparative | 5 | 1.19 | 3.14 | PMMA |
| Example 2 | | | | |

| | Condition for removing foreign substance | | | | |
|---|---|---|---|---|---|
| | | | | | Difference in |
| | | | | | average suction |
| | | | Average | | wind speed |
| | | | suction | | between upper |
| | Pressure | Angle | wind | Conveying | and lower |
| | of air | of air | speed | speed | suction winds |
| | kPa | ° | m/sec | m/min | % |
| Example 1 | 25 | 10 | 0.9 | 5 | 5.0% |
| Example 2 | 5 | 10 | 0.9 | 5 | 5.0% |
| Example 3 | 15 | 10 | 0.9 | 5 | 5.0% |
| Example 4 | 50 | 10 | 0.9 | 5 | 5.0% |
| Example 5 | 25 | 0 | 0.9 | 5 | 5.0% |
| Example 6 | 25 | 30 | 0.9 | 5 | 5.0% |
| Example 7 | 25 | 20 | 0.9 | 5 | 5.0% |
| Example 8 | 25 | 10 | 0.9 | 5 | 5.0% |
| Example 9 | 25 | 10 | 0.9 | 5 | 5.0% |
| Example 10 | 25 | 10 | 1.1 | 5 | 5.0% |
| Example 11 | 25 | 10 | 0.9 | 5 | 5.0% |
| Example 12 | 25 | 10 | 0.9 | 5 | 5.0% |
| Example 13 | 25 | 10 | 0.9 | 5 | 5.0% |
| Example 14 | 25 | 10 | 0.9 | 1 | 5.0% |
| Example 15 | 25 | 45 | 0.9 | 5 | 5.0% |
| Reference | — | — | 0.9 | 5 | 5.0% |
| Example 1 | | | | | |
| Comparative | 25 | 10 | 1.3 | 5 | 5.0% |
| Example 1 | | | | | |
| Comparative | 25 | 10 | 0.6 | 5 | 5.0% |
| Example 2 | | | | | |

| | Condition of | | | | |
|---|---|---|---|---|---|
| | Formul (1) | | | Result | |
| | | Right | | | Foreign |
| | Instal- | side of | | | substance |
| | lation | Formula | | Continuous | removing |
| | interval R | (1) | Restraint | operation | perfor- |
| | mm | mm | of sheet | stability | mance |
| Example 1 | 560 | 832 | Absent | ◯ | ◯ |
| Example 2 | 560 | 832 | Absent | ◯ | ◯ |
| Example 3 | 560 | 832 | Absent | ◯ | ⊙ |
| Example 4 | 560 | 832 | Absent | ◯ | Δ |
| Example 5 | 560 | 832 | Absent | ◯ | Δ |
| Example 6 | 560 | 832 | Absent | ◯ | Δ |
| Example 7 | 560 | 832 | Absent | ◯ | ◯ |
| Example 8 | 250 | 420 | Absent | ◯ | ◯ |
| Example 9 | 560 | 640 | Absent | ◯ | ◯ |
| Example 10 | 560 | 832 | Absent | ◯ | ◯ |
| Example 11 | 560 | 626 | Absent | ◯ | ◯ |
| Example 12 | 560 | 770 | Absent | ◯ | ◯ |
| Example 13 | 560 | 832 | Present | ◯ | ◯ |
| Example 14 | 560 | 832 | Absent | ◯ | ◯ |
| Example 15 | 560 | 832 | Absent | ◯ | Δ |
| Reference | 560 | 832 | Absent | ◯ | X |
| Example 1 | | | | | |
| Comparative | 560 | 832 | Absent | XX | unmeas- |
| Example 1 | | | | | urable |
| Comparative | 560 | 832 | Absent | ◯ | X |
| Example 2 | | | | | |

### Example 16

In the foreign substance removal device used for the polymethyl methacrylate sheet continuous production line, an angle of air blown from the air nozzle inside the suction box was set to 0°, the installation interval (R) of the conveyance supports was set to 560 mm, and the average suction wind speed of suction wind inside the suction box was set to 0.9 m/sec, thereby carrying out continuous production of polymethyl methacrylate sheets (sheet thickness of 5 mm, density: 1.19 g/cm³, Young's modulus: 3.14 GPa). A blowing pressure of air and the conveying speed of the sheet were the same as those in Example 1. Evaluation results are shown in Table 2.

### Examples 17 to 20

Continuous production of polymethyl methacrylate sheets was carried out using a removal device having the same specification as that in Example 16 except that an angle of the air blown from the air nozzle was changed as shown in Table 2. Evaluation results are shown in Table 2.

### Comparative Example 3

Continuous production of polymethyl methacrylate sheets was carried out using a removal device having the same specification as that in Example 16 except that air was not blown from the air nozzle toward the sheet and the inside of the suction box was not sucked. Evaluation results are shown in Table 2.

### Reference Example 2

Continuous production of polymethyl methacrylate sheets was carried out using a removal device having the same specification as that in Example 16 except that the sheet thickness was set to 2 mm and the installation interval (R) of the conveyance supports was set to 560 mm. Evaluation results are shown in Table 2. In the device of the invention which peels foreign substance using air blown from the air nozzle, since the installation interval (R) of the conveyance supports is out of the range of Formula (1), the sheet came into contact with the suction box, and thus a continuous operation could not be performed.

### Reference Example 3

Continuous production of polymethyl methacrylate sheets was carried out using a removal device having the same specification as that in Example 1 except that the sheet thickness was set to 1 mm, iron (density: 7.8 g/cm³, Young's modulus: 200 GPa) was used as a sheet material, and the installation interval (R) of the conveyance supports was set to 700 mm. Evaluation results are shown in Table 2. In the device of the invention which peels foreign substance using air blown from the air nozzle, since the installation interval (R) of the conveyance supports is out of the range of Formula (1), the sheet came into contact with the suction box, and thus a continuous operation could not be performed.

TABLE 2

| | Sheet | | | |
|---|---|---|---|---|
| | | | Young's | |
| | Thickness t | Density d | modulus E | |
| | mm | g/cm³ | Gpa | Material |
| Example 16 | 5 | 1.19 | 3.14 | PMMA |
| Example 17 | 5 | 1.19 | 3.14 | PMMA |
| Example 18 | 5 | 1.19 | 3.14 | PMMA |
| Example 19 | 5 | 1.19 | 3.14 | PMMA |
| Example 20 | 5 | 1.19 | 3.14 | PMMA |
| Comparative | 5 | 1.19 | 3.14 | PMMA |
| Example 3 | | | | |
| Reference | 2 | 1.19 | 3.14 | PMMA |
| Example 2 | | | | |
| Reference | 1 | 7.8 | 200 | Iron |
| Example 3 | | | | |

| | Removing apparatus | | | Result | |
|---|---|---|---|---|---|
| | | | Right | | Foreign |
| | | | side of | | substance |
| | Angle | Installation | Formula | Continuous | removing |
| | of air | interval R | (1) | operation | perfor- |
| | ° | mm | mm | stability | mance |
| Example 16 | 0 | 560 | 832 | ◯ | Δ |
| Example 17 | 10 | 560 | 832 | ◯ | ◯ |
| Example 18 | 20 | 560 | 832 | ◯ | ◯ |
| Example 19 | 30 | 560 | 832 | ◯ | Δ |
| Example 20 | 45 | 560 | 832 | ◯ | Δ |
| Comparative | — | 560 | 832 | ◯ | X |
| Example 3 | | | | | |
| Reference | 10 | 560 | 497 | XX | unmeas- |
| Example 2 | | | | | urable |
| Reference | 10 | 700 | 640 | XX | unmeas- |
| Example 3 | | | | | urable |

Unmeasurable: Removal performance could not be evaluated because the operation stop system was activated immediately after starting the operation.
PMMA refers to a polymethyl methacrylate sheet.
PC refers to a polycarbonate sheet.

### EXPLANATIONS OF LETTERS OR NUMERALS

1a: conveyance support (inlet side of suction box)
1b: conveyance support (outlet side of suction box)
2: sheet
3a: suction box (upper side)
3b: suction box (lower side)
4a: air nozzle (upper side)
4b: air nozzle (lower side)
5a: suction port (upper side)
5b: suction portion (lower side)
6: sheet shaping device
7: masking adhesive device
8: circular saw cutting machine (flow direction of sheet)
9: circular saw cutting machine (width direction of sheet)
10: contact detection sensor

1. A method of removing foreign substance attached to a sheet, the method comprising:
sucking the foreign substance from a suction box B1 and a suction box B2 installed to face each other with the sheet interposed therebetween between a conveyance support A1 and a conveyance support A2 conveying the sheet,
wherein an average suction wind speed of suction wind from openings of the suction boxes B1 and B2 is in a range of 0.8 to 1.2 m/sec.

2. The method of removing foreign substance according to claim 1, further comprising:
cutting the sheet before the foreign substance is sucked from the suction box B1 and the suction box B2.

3. The method of removing foreign substance according to claim 1, wherein the foreign substance is separated from above the sheet by air blown from air nozzles inside the suction boxes B1 and B2.

4. The method of removing foreign substance according to claim 3, wherein an installation interval R between the conveyance support A1 and the conveyance support A2 satisfies the following formula (1):
R≤320×(E×t²/d)^{0.25}−80 (1),
wherein R denotes the installation interval (mm) between the conveyance support A1 and the conveyance support A2, E denotes a Young's modulus (GPa) of the sheet, t denotes a thickness (mm) of the sheet, and d denotes density (g/cm³) of the sheet.

5. The method of removing foreign substance according to claim 3, wherein a pressure of air blown from the air nozzles is in a range of 2 to 60 kPa.

6. The method of removing foreign substance according to claim 1, wherein a difference Δv between average suction wind speeds of suction wind in the suction boxes B1 and B2 calculated from formula (2) below is 5.0 or less:
Δv=(|V1−V2|/Va)×100 (2)
wherein
V1 denotes an average suction wind speed in the suction box B1,
V2 denotes an average suction wind speed in the suction box B2, and
Va denotes an average value of the average suction wind speeds in the suction boxes B1 and B2.

7. The method of removing foreign substance according to claim 3, wherein an angle θ1 formed by a blowing direction of air blown from the air nozzles and a direction perpendicular to a sheet surface is in a range of 0 to 40°.

8. The method of removing foreign substance according to claim 5, wherein a pressure of air blown from the air nozzles is in a range of 3 to 30 kPa.

9. The method of removing foreign substance according to claim 7, wherein the angle θ1 is in a range of 5° to 25°.

10. The method of removing foreign substance according to claim 7, wherein an angle θ2 formed by a conveying direction of the sheet and a blowing direction obtained by projecting the blowing direction of air blown from the air nozzles onto the sheet surface is in a range of 0° to 5°.

11. The method of removing foreign substance according to claim 1, wherein the sheet travels on the conveyance supports in an unrestrained state.

12. The method of removing foreign substance according to claim 1, wherein a Young's modulus of the sheet is in a range of 1.4 to 15.2 GPa.

13. The method of removing foreign substance according to claim 1, wherein a thickness of the sheet is in a range of 0.5 to 15 mm.

14. A device for removing foreign substance attached to a sheet, the device comprising:
a conveyance support A1 and a conveyance support A2 that convey the sheet; and
a suction box B1 and a suction box B2 installed to face each other with the sheet interposed therebetween between the conveyance supports A1 and A2,
wherein an installation interval R between the conveyance support A1 and the conveyance support A2 satisfies the following formula (1):
R≤320×(E×t²/d)^{0.25}−80 (1),
wherein
R denotes the installation interval (mm) between the conveyance support A1 and the conveyance support A2, E denotes a Young's modulus (GPa) of the sheet, t denotes a thickness (mm) of the sheet, and d denotes density (g/cm³) of the sheet, and
air nozzles are included in the suction box B1 and the suction box B2.

15. The device for removing foreign substance according to claim 14, wherein an angle θ1 formed by a direction of the air nozzles and a direction perpendicular to a sheet surface is in a range of 0 to 40°.

16. The device for removing foreign substance according to claim 15, wherein the angle θ1 is in a range of 5 to 25°.

17. The device for removing foreign substance according to claim 15, wherein an angle θ2 formed by a conveying direction of the sheet and a blowing direction obtained by projecting a blowing direction of air blown from the air nozzles onto the sheet surface is in a range of 0° to 5°.

18. The method of removing foreign substance according to claim 4, wherein a difference Δv between average suction wind speeds of suction wind in the suction boxes B1 and B2 calculated from formula (2) below is 5.0 or less:
Δv=(|V1−V2|/Va)×100 (2)
wherein
V1 denotes an average suction wind speed in the suction box B1,
V2 denotes an average suction wind speed in the suction box B2, and
Va denotes an average value of the average suction wind speeds in the suction boxes B1 and B2.

19. The method of removing foreign substance according to claim 4, wherein the sheet travels on the conveyance supports in an unrestrained state.

20. The method of removing foreign substance according to claim 4, wherein a Young's modulus of the sheet is in a range of 1.4 to 15.2 GPa.

21. The method of removing foreign substance according to claim 4, wherein a thickness of the sheet is in a range of 0.5 to 15 mm.

22. The device for removing foreign substance according to claim 16, wherein an angle θ2 formed by a conveying direction of the sheet and a blowing direction obtained by projecting a blowing direction of air blown from the air nozzles onto the sheet surface is in a range of 0° to 5°.
